(19) United States
(12) Patent Application Publication
(10) Pub. No.: US 2003/0103624 A1
(43) Pub. Date: Jun. 5, 2003

(54) Slip casing for mobile phone

(75) Inventor: Hui Sen Hu, Taipei (TW)

Correspondence Address: DAVID E. DOUGHERTY, DENNISON SCHULTZ & DOUGHERTY, 612 CRYSTAL SQUARE 4, 1745 JEFFERSON DAVIS HIGHWAY, ARLINGTON, VA, 22202, US

(73) Assignee: Kingston Cell Taiwan Corp.

(21) Appl. No.: 10/002,207

(22) Filed: Dec. 5, 2001

(51) Int. Cl. H04M 1/00

(52) U.S. Cl. 379/455

(57) ABSTRACT

An improved slip casing for a mobile phone made of elastomer, it is comprised of a casing and a fixing clip, the fixing clip is provided at a suitable location on the casing. By providing an elastic clamping portion on the casing, the mobile phone is clamped in the casing; and by providing the fixing clip, the casing with the mobile phone can be engaged on a belt at any suitable position on one's body. Thereby, an effect of convenient carrying is achieved.

### BACKGROUND OF THE INVENTION

1. Field of the Invention

The present invention is related to an improved slip casing for a mobile phone, and especially to a slip casing made of elastomer and able to clamp and hold the mobile phone and can be worn on one's body with a fixing clip, it is especially suitable for carrying the mobile phone or other similar portable devices.

2. Description of the Prior Art

In the modern age with prevailing information and time competition, mobile phones have been necessary tools for mass communication. For the purpose that mobile telephones can be conveniently taken and packed up for storage, various types of structures for carrying them have been developed. People of many Asian countries generally have mobile phones received in same type of protecting case and wear them on waistbands, while people of European and American countries tend to place mobile phones in a kind of mobile phone slip casing structure, as shown in FIG. 1, in such a structure, a trapezoid box which is wider on the upper edge and narrower on the lower edge is provided, the rear side of the box has a clip, the box with a suitable shape interiorly which is wider on the upper edge and narrower on the lower edge renders a mobile phone to be engaged in the slip casing, and is clamped at a suitable location on a waistband with the clip, so that the mobile phone is convenient for carrying. However, such a structure has the following defects when in use:

1. The slip casing has not been designed to prevent the mobile phone from dropping, it is made of hard plastic and is smooth on the surface thereof and lacks frictional resisting force, and no binding effect can be obtained. The mobile phone is subjected to dropping off the slip casing by vibration from a violent action in activity of the user.

2. Among the products now available, no matter they are slip casings or protecting cases, the clips of them never have well specified, they are only hung on waistbands in a simple way for use, they can not be further developed to be worn on a wrist or an arm for use, their positions of wearing are limited and thereby are not desired.

In view of this, the inventor of the present invention provides an improved slip casing for a mobile phone after hard study and improvement, in order that a user can use it with only a hand to firmly clamp it on one's body, and the mobile phone is hard to be dropped off the slip casing.

### SUMMARY OF THE INVENTION

The main object of the present invention is to provide an improved slip casing for a mobile phone, the casing has moderate hardness and is endued with good frictional resisting force, it can effectively clamp a mobile phone on the slip casing and avoid inadvertent dropping of the mobile phone off the slip casing by providing a clamping portion and an arciform portion.

Another object of the present invention is to provide an improved slip casing for a mobile phone, the mobile phone can be conveniently taken out or placed and fixed in the slip casing by providing an elastic means hidden in the clamping portion.

In order to get the above stated objects, the present invention is made of elastomer with moderate hardness, and is comprised of a casing and a fixing clip, the casing is provided at a suitable location thereon with the fixing clip; by providing the elastic clamping portion on the casing, the mobile phone is clamped in the casing, and by providing the fixing clip, the casing with the mobile phone can be firmly worn on one's body, so that the mobile phone can be conveniently carried.

The present invention will be apparent in its features and detailed structure after reading the detailed description of the preferred embodiment thereof in reference to the accompanying drawings.

### BRIEF DESCRIPTION OF THE DRAWINGS

FIG. 1 is a perspective view of a conventional structure;

FIG. 2 is a perspective view of a preferred embodiment of the present invention;

FIG. 3 is a side view the embodiment of the present invention;

FIG. 4 is a schematic view showing use of the embodiment of the present invention;

FIG. 5 is a front view of another embodiment of the present invention;

FIG. 6a is a sectional schematic view showing a mobile phone is clamped in the aforesaid another embodiment of the present invention;

FIG. 6b is a sectional schematic view showing the mobile phone is loosened from the aforesaid another embodiment of the present invention;

FIG. 7 is a perspective view of a further embodiment of the present invention;

FIG. 8 is a perspective view of an elastic means of the further embodiment of the present invention;

FIG. 9a is a sectional schematic view showing a mobile phone is clamped in the aforesaid further embodiment of the present invention;

FIG. 9b is a sectional schematic view showing the mobile phone is loosened from the aforesaid further embodiment of the present invention.

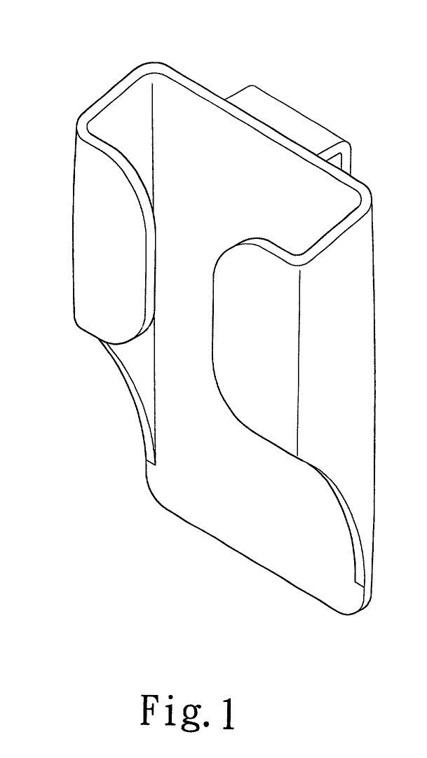

### DETAILED DESCRIPTION OF THE PREFERRED EMBODIMENT

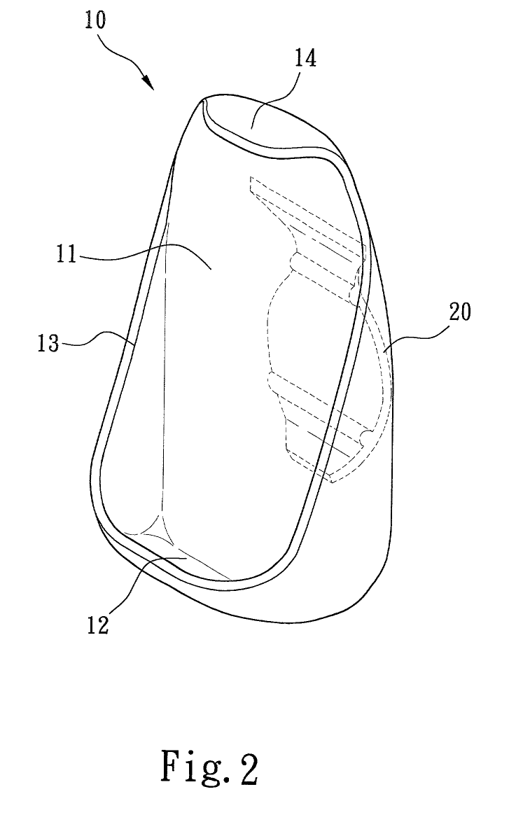

Referring firstly to FIG. 2, the improved slip casing for a mobile phone of the present invention is comprised mainly of a casing 10 made of elastomer with moderate hardness, and is comprised of a fixing clip 20.

Wherein, the casing 10 is made of elastomer such as rubber or silicone to have a receiving chamber 11 for receiving a mobile phone 40; the bottom thereof is an arciform portion 12 slightly curved upwardly, the front side thereof is opened, while the lateral sides thereof are cut to leave bevel edges 13, the top thereof is formed to have an arci form clamping portion 14 slightly bending downwardly, and the rear side thereof is provided with the fixing clip 20.

The fixing clip 20 is an elastic arched member, it is connected on one end thereof to the casing 10, and the other end thereof has an inwardly bending portion 21, a plurality of engaging ribs 22 are provided on the inner side thereof to fix the slip casing for a mobile phone.

By virtue that the present invention is made of elastomer such as rubber or silicone, it has better frictional resistance and certain stiffness as well as elasticity, when the casing 10 is combined with the fixing clip 20, they are pin connected or connected by tenon jointing, or they can be combined by integrally forming by molding, to thereby complete a structure of slip casing with the internal receiving chamber 11 for a mobile phone able to hang on one's body.

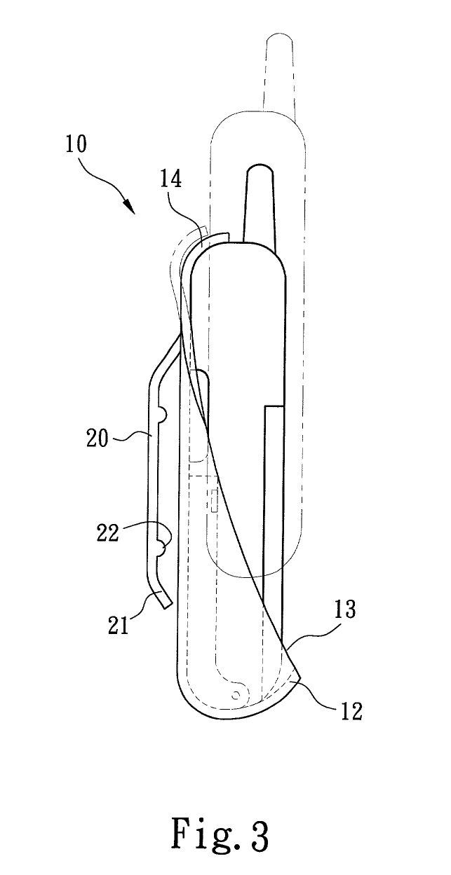

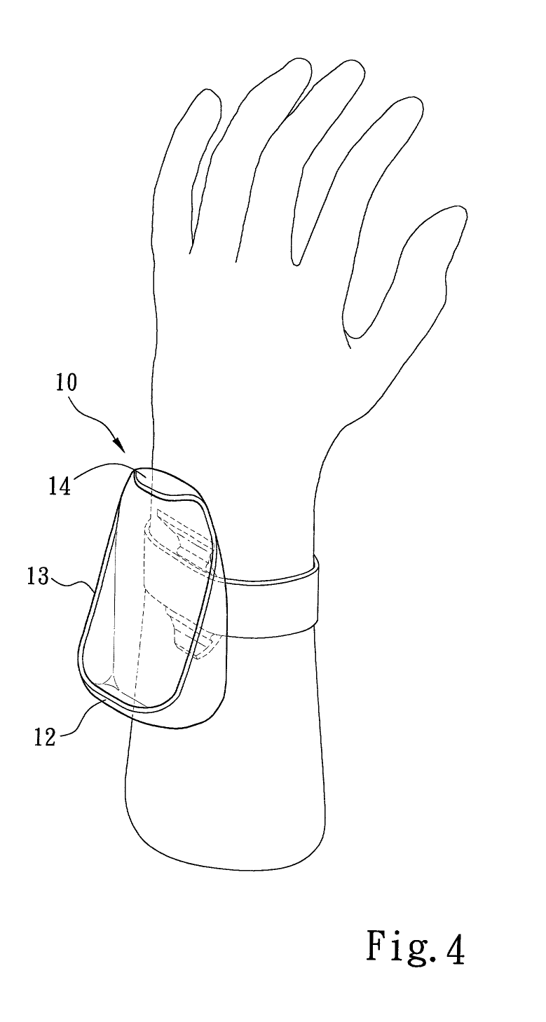

Referring to FIG. 3, when the present invention receives a mobile phone 40, the mobile phone 40 is pressed down just with a hand into the receiving chamber 11. By virtue that the present invention is made of elastomer, the clamping portion 14 on the upper area of the casing 10 is bent rearwardly in the first place and then moves back forwardly to hold the mobile phone 40; while the arciform portion 12 on the lower area of the casing 10 is in the shape coincident with that of the mobile phone 40 to thereby be able to hold firm the mobile phone 40 and to avoid it from slipping off. The lateral bevel edges 13 can make positioning of the mobile phone 40 in the casing 10 without sliding sidewards. Referring to FIG. 4, when in application of the present invention, the fixing clip 20 specifically designed to have the engaging ribs 22 thereon can engage a waistband between the engaging ribs 22 of the fixing clip 20 to thereby strengthen the fixing force of the fixing clip 20 and avoid dropping of the casing 10. Not only the fixing clip 20 provided on the rear side of the casing 10 can clamp the casing 10 on the waistband, by providing the engaging ribs 22, the casing 10 can also be conveniently worn on a wristband of the user without worrying of dropping. And the user can have many options to wear the casing 10 at any convenient position on his body.

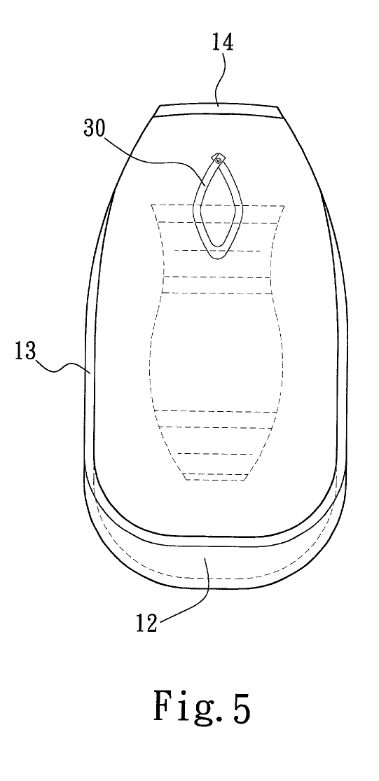

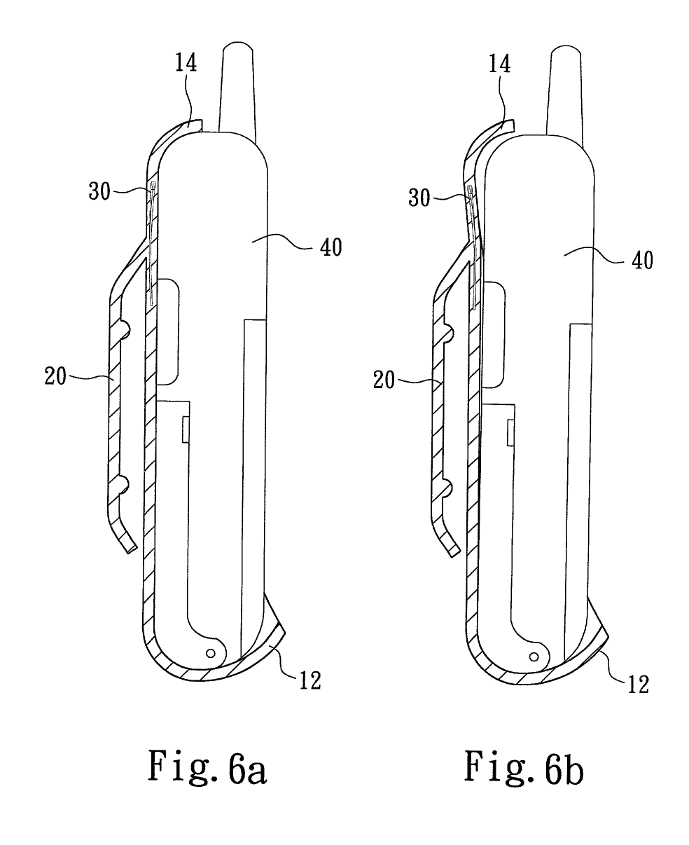

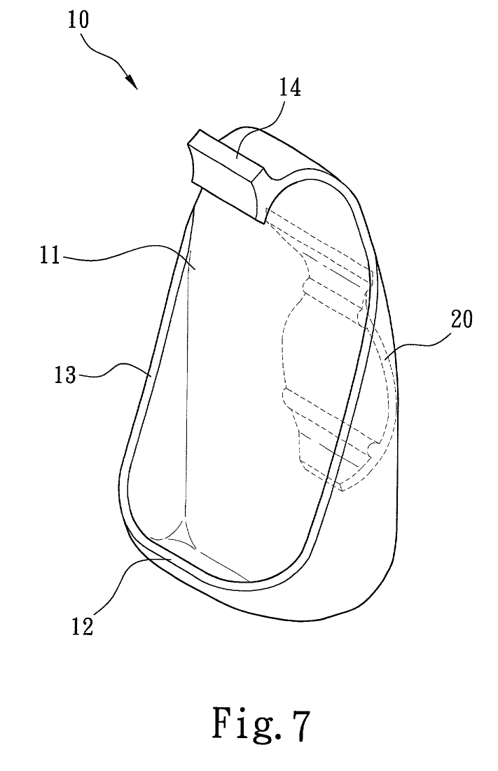

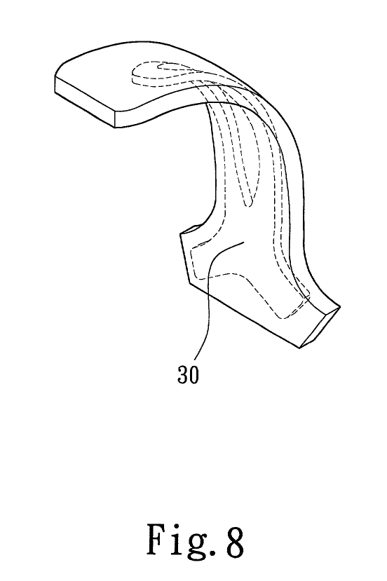

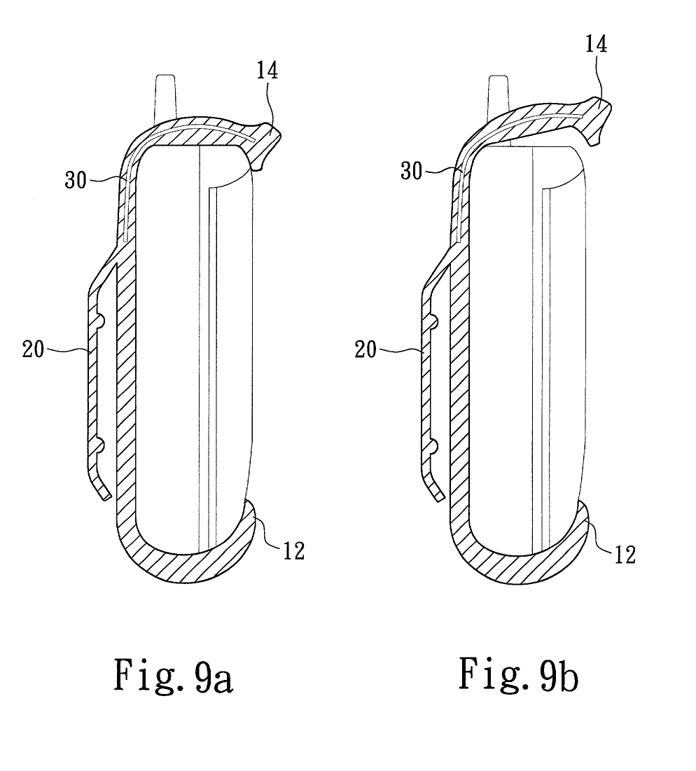

Referring to FIG. 5 which shows another embodiment of the present invention, it has a structure which is a strengthened one as compared to the abovementioned embodiment, these two are identical apparently, but it is different in that, a bent piece 30 is embedded in the casing 10 at a suitable location and is a “U” shaped metallic piece, two front ends thereof are connected with a rivet to make it bended to form the bent piece 30, it has elasticity just like a hair clip. When in manufacturing, the bent piece 30 is packed in a plastic sleeve, and then is placed in a mold to be formed integrally in the inner wall of the casing 10, referring to FIGS. 6a and 6b; by virtue that it has certain restorable elasticity after bending, it can be bent and positioned in two different positions. When the bent piece 30 is embedded in the casing 10 near the top of the latter, by the nature that it can be bent and positioned in two different positions, the clamping portion 14 can have two states, i.e., opening and clamping states, this not only can increase the holding force of the casing 10 on the mobile phone 40, but also the mobile phone 40 can be taken off the casing 10 easily with only one hand. The slip casing formed thereby has the features of being convenient for pressing, engaging, taking out as well as placing in the mobile phone. Referring to FIGS. 7 and 8 which show a further embodiment of the present invention, its structure is different in another bent piece 30, the bent piece 30 is an elastic arci form metallic piece which is embedded in the clamping portion 14 of the casing 10 to strengthen the clamping force of the clamping portion 14, referring to FIGS. 9a and 9b; by the restorable elasticity after bending provided on the bent piece 30, the mobile phone 40 can be taken off the casing 10 easily by moving away the clamping portion 14 with only one hand.

The present invention has the following advantages accordingly:

1. The present invention is made of elastomer with good frictional resisting force, by providing the clamping portion and the arciform portion, it can effectively clamp and hold a mobile phone in the casing to avoid inadvertent dropping of the latter, hence it is practical in use.

2. The present invention is provided with a fixing clip having engaging ribs thereon, the fixing clip can be firmly clamped on a belt, thus it has the practicality of firm positioning, and it can be applied on a wristband, thereby mobility as well as adaptability can be increased.

3. The present invention is provided with an elastic clamping portion, so that a mobile phone can be taken off or fixed to the slip casing more easily, hence it is convenient for use.

The present invention described and shown is not limited to the embodiments described and shown in the drawings. It will be apparent to those skilled in this art that various modifications or changes can be made to the elements of the present invention without departing from the spirit, scope of this invention. Accordingly, all such modifications and changes also fall within the scope of the appended claims and are intended to form part of this invention. In conclusion, the present invention not only can get rids of the defects resided in the conventional slip casing for mobile phones, but also can get the functions of firmly clamping a mobile phone and clamping the slip casing on a belt by making the slip casing of elastomer and by providing the clamping portion. In this way, practicality and convenience of the present invention is largely increased for being suitable of using in various mobile phones.

Therefore, what I claim as new and desire to be secured by Letters Patent of the United States are:

1. An improved slip casing for a mobile phone, being comprised of a casing and a fixing clip; wherein,
said casing is made of elastomer with moderate hardness, the bottom side, lateral sides, rear side and the top side thereof form a receiving chamber for receiving said mobile phone;
said fixing clip is a elastic arched member, it is connected on one end thereof with said casing, and the other end thereof is provided with an inwardly bending portion to fix said slip casing for said mobile phone.

2. An improved slip casing for a mobile phone as defined in claim 1, wherein,
said casing is made of rubber or silicone, said bottom side thereof is an arciform portion slightly curved upwardly, said lateral sides thereof are cut to leave two bevel edges to hold firm said mobile phone and to avoid it from sliding sidewards, said top side thereof is formed to have an arciform clamping portion slightly bending downwardly, a plurality of engaging ribs are provided on the inner side of said fixing clip, so that when said casing is combined with said fixing clip, they are adapted to pin connecting with each other.

3. An improved slip casing for a mobile phone as defined in claim 1, wherein,
said fixing clip is combined by integrally forming by molding with said casing.

4. An improved slip casing for a mobile phone as defined in claim 1, wherein,
an elastic bent piece is embedded in said casing.

5. An improved slip casing for a mobile phone as defined in claim 4, wherein,
said bent piece is a “U” shaped metallic piece, two front ends thereof are connected with a rivet to make it bended.
